(19) United States
(12) Patent Application Publication
(10) Pub. No.: US 2019/0180214 A1
(43) Pub. Date: Jun. 13, 2019

(54) HUMAN RESOURCE MANAGEMENT SYSTEM AND METHOD

(71) Applicants: Kevin FEARN, Land O Lakes, FL (US); Patricia DI GASBARRO, Toronto (CA)

(72) Inventors: Kevin FEARN, Land O Lakes, FL (US); Patricia DI GASBARRO, Toronto (CA)

(21) Appl. No.: 16/213,935

(22) Filed: Dec. 7, 2018

Related U.S. Application Data
(60) Provisional application No. 62/595,846, filed on Dec. 7, 2017.

(51) Int. Cl. G06Q 10/06; G06Q 10/10

(52) U.S. Cl. CPC G06Q 10/06393; G06Q 10/105; G06Q 10/06398

(57) ABSTRACT

A method and system for managing human resources are provided. Personnel data for a plurality of persons is stored in storage of a computer system. Employer-provided evaluation data for a first subset of the plurality of persons is also stored in storage. A candidate data structure having a plurality of dimensions is generated from the personnel data and the employer-provided evaluation data for each of a second subset of the plurality of persons. The candidate data structure for each of the second subset of the plurality of persons is scored for a proposed employment term. At least one of the second subset of the plurality of persons is identified and presented at least partially based on the scoring.

### CROSS-REFERENCE TO RELATED APPLICATIONS

This application claims priority to U.S. Provisional Application No. 62/595,846, filed Dec. 7, 2017, the entire content of which is incorporated herein in its entirety.

### FIELD

The specification relates generally to a human resources management system. In particular, the following relates to a human resources management system and method.

### BACKGROUND OF THE DISCLOSURE

Contingent workers are often employed by companies to address short- to medium-term requirements. When a company identifies a project that it does not have the human resources to complete, it defines the type of employees desired, the estimated period of the employment term, the location, the compensation rate range, etc. Often, the company will engage one or more contract employee agencies to assist with locating and onboarding suitable candidates. This process can be slow, and can return candidates who may not be well suited, high risk, or inappropriate to the task and/or environment at hand. Further, the status of this process can be difficult to measure, resulting in the poorly managed onboarding of employees.

### SUMMARY OF THE DISCLOSURE

In one aspect, there is provided a method for managing human resources, comprising storing, in storage of a computer system, personnel data for a plurality of persons, storing employer-provided evaluation data for a first subset of the plurality of persons, generating a candidate data structure having a plurality of dimensions from the employer-provided evaluation data and the personnel data for each of a second subset of the plurality of persons, scoring, for a proposed employment term, the candidate data structure for each of the second subset of the plurality of persons, and identifying and presenting at least one of the second subset of the plurality of persons at least partially based on the scoring.

The method can further comprise identifying at least one target data structure, each having the plurality of dimensions for a target candidate for the proposed employment term, wherein the scoring comprises comparing at least a subset of the dimensions of the candidate data structure and the at least one target data structure for each of the second subset of the plurality of past employees.

The at least one target data structure can comprise at least one of the candidate data structures, and the method can further comprise comparing the candidate data structure for each of the second subset of the plurality of persons to the candidate data structure for a third subset of the first subset of the plurality of persons.

The third subset can be equal to the first subset.

The third subset can be smaller than the first subset.

The scoring can comprise using a weighting to value the differences along each of the subset of the dimensions of the candidate data structure and the target data structure.

The method can further comprise receiving a selection of the at least one of the second subset of the plurality of persons, and adjusting the weightings based on the selection.

In some cases, the candidate data structure can be a data vector, a data graph, or a hybrid data structure.

According to another aspect, there is provided a human resource management system, comprising a storage storing a personnel data for a plurality of persons and employer-provided evaluation data for a first subset of the plurality of persons, the storage storing computer-executable instructions, a processor that, when executing the computer-executable instructions, generates a candidate data structure having a plurality of dimensions from the personnel data and the employer-provided evaluation data for each of a second subset of the plurality of persons, scores, for a proposed employment term, the candidate data structure for each of the second subset of the plurality of persons, and identifies and presents at least one of the second subset of the plurality of persons at least partially based on the scoring.

### BRIEF DESCRIPTIONS OF THE DRAWINGS

For a better understanding of the embodiment described herein and to show more clearly how they may be carried into effect, reference will now be made, by way of example only, to the accompanying drawings in which:

FIG. 1 shows a human resource matching system in accordance with one embodiment thereof;

FIG. 2 shows various logical components of the system of FIG. 1 and its operating environment;

FIG. 3 shows various types of data adapters and the data sources they handle;

FIG. 4 shows the general method of human resource matching using the system of FIG. 1; and

FIG. 5 shows the general process of matching candidate employees to a context.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

A method and computer system for managing human resources in accordance with an embodiment are described herein. Personnel data is stored by the computer system for a plurality of persons; in particular, past, current, and proposed contingent employees. The computer system can also store personnel data for past, current, and proposed non-contingent employees in some cases. Employer-provided evaluation data for a first subset of the plurality of persons is also stored. A candidate data structure having a plurality of dimensions is generated from the personnel data and may include any associated employment term data, term context data, employer-provided evaluation data, and employee-provided evaluation data for each of a second subset of the plurality of persons. The candidate data structure for each of the second subset of the plurality of persons is scored for a proposed employment term. At least one of the second subset of the plurality of persons is identified and presented at least partially based on the scoring.

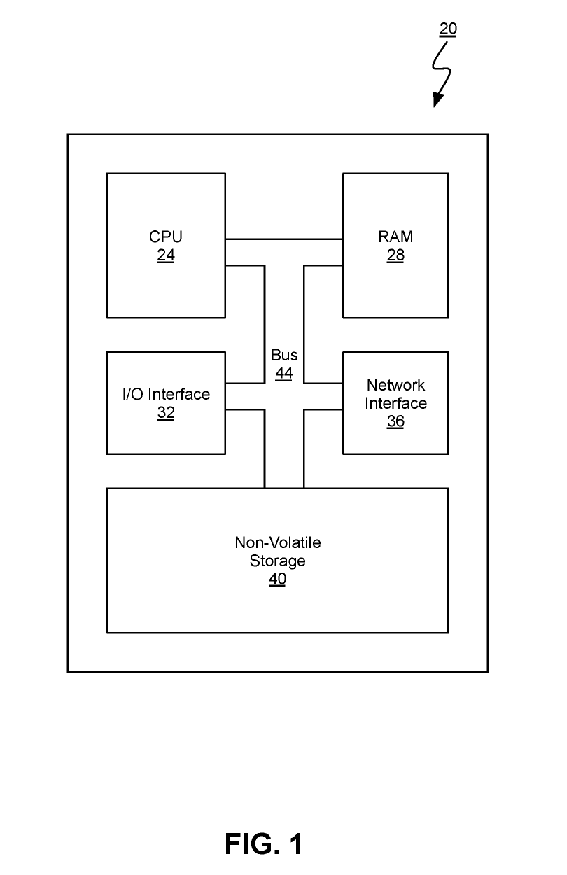

FIG. 1 shows various physical elements of a computer system 20 for human resource management in accordance with an embodiment. Computer system 20 tracks contingent employees before, during, and after employment with an entity, such as a company. When the company has a need for contingent workers, it can rapidly consider the contingency workers that it previously employed, as well as other candidates, to determine if there is a fit. Onboarding can be accelerated as previously collected personnel data and background checks can be reused instead of discarded.

The physical components include a central processing unit (“CPU”) 24, random access memory (“RAM”) 28, an input/output (“I/O”) interface 32, a network interface 36, non-volatile storage 40, and a local bus 44 enabling CPU 24 to communicate with the other components. CPU 24 executes at least an operating system, and other components as will be described. RAM 28 provides relatively responsive volatile storage to CPU 24. I/O interface 32 allows for input to be received from one or more devices, such as a keyboard, a mouse, etc., and outputs information to output devices, such as a display and/or speakers. Network interface 36 permits communication with other computing devices over computer networks. Non-volatile storage 40 stores the operating system and programs, including computer-executable instructions for implementing a human resource management system. During operation of computer system 20, the operating system, the programs and the data may be retrieved from non-volatile storage 40 and placed in RAM 28 to facilitate execution.

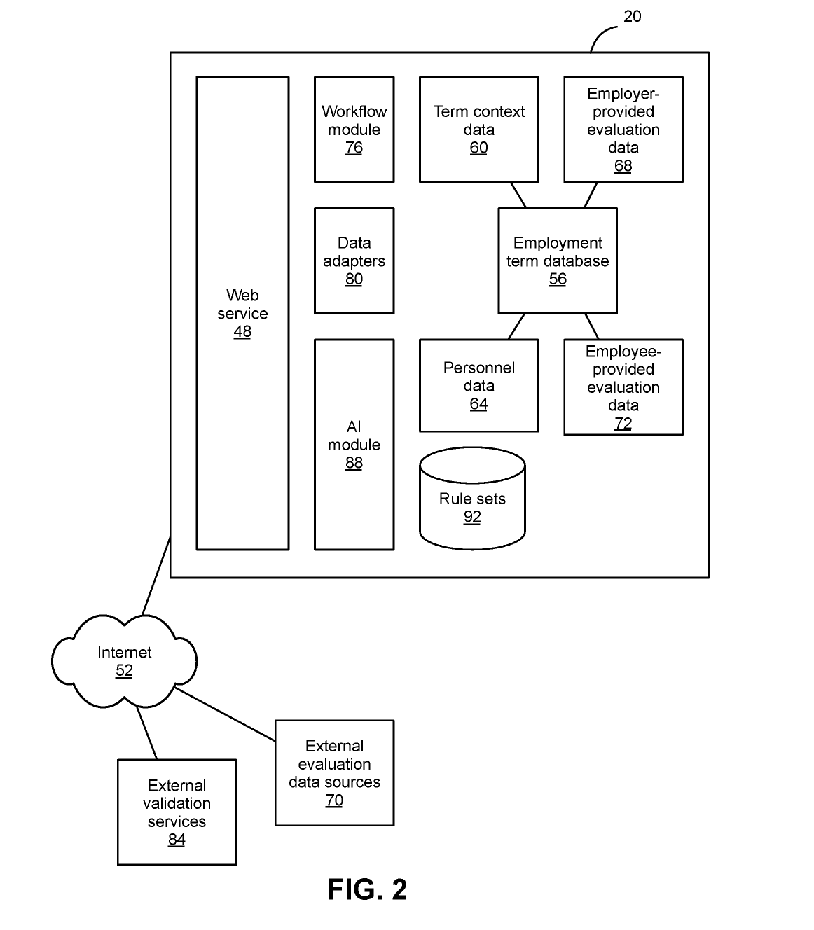

FIG. 2 shows various logical components of the human resource management system implemented by computer system 20. The system has a web service 48 enabling users on computing devices in communication with computer system 20 over one or more public or private computer networks, such as the Internet 52, to interact with the other components.

The human resource management system stores employment term data in an employment term database 56. An employment term is a period of employment of an employee with an entity, such as a company, an association, an organization, etc. In this particular embodiment, the employment terms are generally contract terms for contingent employees, but in other embodiments, the employment terms can also include other employment terms, such as periods of permanent full-time or part-time employment. The employment term data is data that describes employment terms. In one example, a company may decide that it wants to develop a customer facing mobile application. The development of the mobile application can entail one or more projects, such as the development of the mobile application that executes on mobile devices, the development of the server(s) with which the mobile application communicates to send and receive data, etc. One or more employment terms may be defined for each projection, corresponding to the number of employees required. The employment term data can include, for example, the start date, the end date, the utilization rate during the employment term (number of hours required per week), the location, the role, the salary and other ancillary compensation, etc. Employment term data can be stored for each past, current, and upcoming employment term.

Term context data 60 stored by computer system 20 represents data for the context in which the employment term is being performed. Term context data 60 can be more or less granular, as desired. In some cases, term context data 60 can identify the direct manager overseeing the employment being performed, and can also identify co-workers. In some cases, term context data 60 can correspond to a single company or group of companies, and, where desired, can be implicitly implied where coarse granularity is deemed sufficient.

Personnel data 64 includes basic data, address data, skills data, background check data, etc. Basic data can include the person's name, date of birth, gender, social insurance number. The address data includes the residential address of the person, and any contact information for the person, including telephone numbers, email addresses, etc. The skills data can include any relevant skills possessed, being worked towards, or desired by the person. Background check data can include any background checks that are typically performed during the onboarding of an employee. Personnel data 64 can include one or more documents used as source material, for example, for skills.

Employer-provided evaluation data 68 includes any evaluation/assessment data registered by employer(s) about the performance and/or fit of employees. Typically, each employment term has one or more sets of evaluations performed by the associated employer.

Employee-provided evaluation data 72 includes any evaluation/assessment data registered by an employee or former employee about an employment term. This may be collected, for example, during an exit interview, via an online survey, etc.

A workflow module 76 controls the collection of data, onboarding, and offboarding of employees. Workflow module 76 has a set of bots that are accessible to the web service 48 and perform tasks according to defined workflows, such as collecting data and evaluations from both employees and employers, performing or confirming background checks in preparation for the start of an employment term, and communicating information during the onboarding, employment, and offboarding of employees. Automation of the onboarding process ensures that issues can be addressed in a timely manner before they become critical, such as flagging missing social security information for a future employee. Bots can manage communication such as via email, phone, SMS, etc. with candidate employees, determine if personnel are available for employment, etc. Bots can also conduct surveys, such as exit surveys, via web service 48 or via telephone, collect the data, process it to identify data such as employee-provided evaluation data, and flag unidentified data for human processing.

Data adapters 80 are employed by workflow module 76, to handle the collection of both employer-provided evaluation data 68, evaluation data for the candidate employees from external evaluation data sources 70, and employee-provided evaluation data 72, as well as the collection of term context data 60 and personnel data 64. The evaluation data from external evaluation data sources 70 can be used to augment or replace the employer-provided evaluation data in some cases.

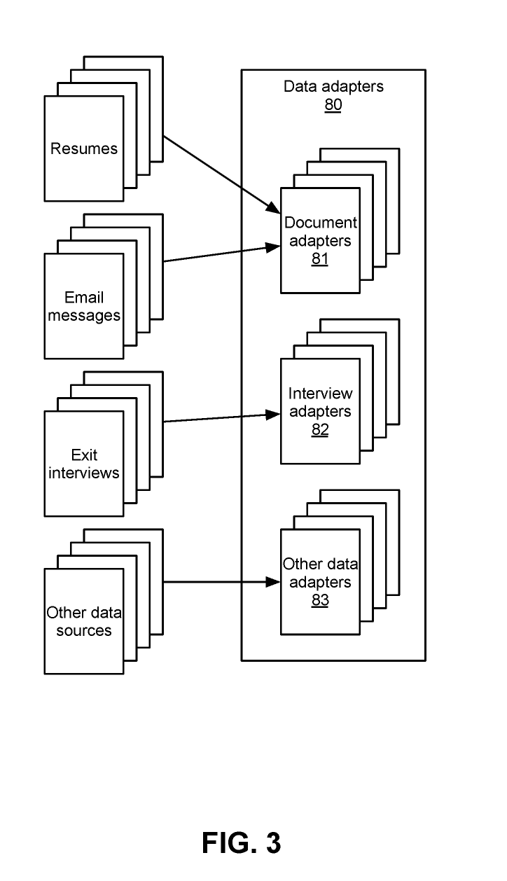

FIG. 3 shows various data adapters 80 for handling this collection. Document adapters 81 handle various types of electronic documents. Document adapters 81 can be arranged or configured to extract data from resumes, email messages, etc. For example, one particular type of document adapter 81 can use natural language processing to parse electronic resumes and extract personnel data 64 including basic data, address data, and skills data. Interview adapters 82 collect employer-provided evaluation data and employee-provided evaluation data during an evaluation interview, such as at offboarding (typically referred to as an exit interview). Other data adapters 83 collect data from other sources on behalf of the bots of workflow module 76.

Workflow module 76 also communicates with one or more external validation services 84 that perform background checks on candidate employees.

Returning again to FIG. 2, an artificial intelligence (“AI”) module 88 performs matching of candidate employees to proposed employment terms. A proposed employment term is a potential future employment term that has been scoped by an employer. The proposed employment term can be associated with a term context, such as a particular manager and team. A candidate employee is any person that is considered for employment during a proposed employment term.

Al module 88 uses rule sets 88 to filter and match candidate employees to proposed employment terms. The rule sets 88 include hard rules and soft rules. Hard rules are used to ensure that requirements for a proposed employment term are satisfied. An English representation of an exemplary hard rule is “must be able to come to the employment location every day”. Soft rules are used to define flexible limitations for a proposed employment term. An English representation of an exemplary soft rule is “has 5+ years of experience with C++”.

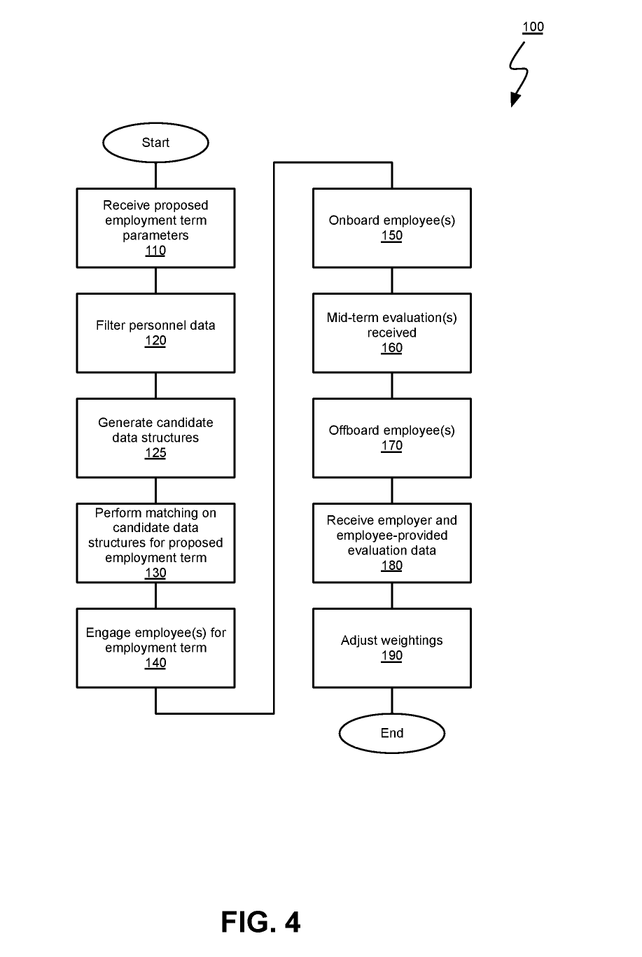

The general method 100 of human resources management performed by computer system 20 will now be described with reference to FIGS. 1 to 4. Method 100 commences with the receiving of proposed employment term parameters (110). The proposed employment term parameters can include a start date, a proposed end date, a location, a proposed salary rate, term context data such as the manager overseeing the role(s) and the team in which the role will operate, required and preferred skills, etc.

Personnel data 64 is then filtered (120). Computer system 20 uses the proposed employment term parameters to filter personnel data 64 to identify a subset as candidate employees for the proposed employment term. Personnel data 64 can include new personnel data registered for new applicants from a job posting, an agency, etc. Candidate data structures are then generated from the personnel data and the corresponding employment term data, as well as the associated employer-provided evaluation data 68 and the employee-provided evaluation data 72 (125). In particular, for each person, the personnel data is combined with the corresponding employment term data (if any), as well as any associated employer-provided evaluation data 68 or employee-provided evaluation data 72 to generate a candidate data structure. The candidate data structure can be a data vector in some embodiments. In other embodiments, the candidate data structure can be a data graph. In still further embodiments, the candidate data structure can be a hybrid of a data vector and a data graph.

Matching is then performed on the filtered personnel data 64 for the proposed employment term (130). Candidate employees are evaluated based on how closely they match a target candidate profile generated by the entity.

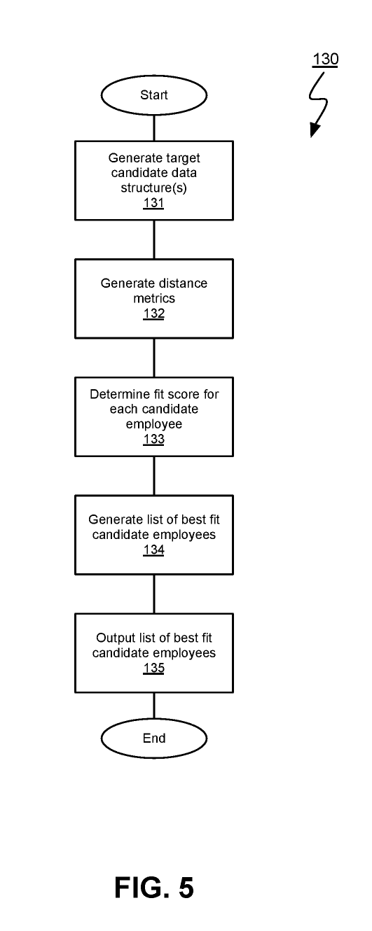

FIG. 5 illustrates the matching of candidate employee data for the proposed employment term at 130 in greater detail. A target candidate data structure is generated (131). The target candidate data structure, in some cases, can be based on a single actual past employee data structure or a composite of actual past employee data structures. In other cases, the target data structure can be based on a fictitious candidate data structure that is best effort. The target data structure can be at least partially trained based on employer preferences.

Distance metrics are generated (132). The determination of the distance metrics is dependent on the type of data structures being employed. Where the data structures are data vectors, the distance metrics are determined using a Euclidian distance model. Where, instead, the data structures are data graphs, a graph distance model is employed. The distance here can be hops from one candidate to another, common nodes between a candidate data graph and a target data graph, common edges, or flow rate. For example, Graph2vec can be employed to determine the distance metrics for data graphs. Where the data structure is a hybrid model, a mix of the Euclidian distance model and the graph distance model is employed.

A fit score is then determined for each candidate employee (133). The fit score is determined based on the distance metrics and the weightings. When data is not explicitly available, computer system 20 can use Bayesian inference to infer the missing data. That is, if there is a high probability of A when B is present, and be is present, assume candidate has A. An example might be that students who also had a job as research assistant are as good as full time employees with 2+ years of experience. Therefore, when there is a soft rule of 2+ years, count research assistants, even though that is a part time role. Candidates with similar positive reviews may be preferable to hire. It is not necessarily the case that a high score is preferable in all categories. An employer might prefer “finished in time” to “gets to work on time”.

For candidates who have no employer-provided evaluation data, as they may not have worked for the employer, computer system 20 can try to correlate the candidate using the personnel data with one or more other candidates for which employer-provided evaluation data is available.

The weights in a neural network provide the rules. Some are “hard”, meaning that the rules cannot be broken. Others are “soft”, meaning that computer system 20 can venture beyond these rules. Subsequent feedback during the learning process helps computer system 20 to learn how “soft” the rules are.

A weighting used to determine the importance of each dimension is used to score the candidate employee data structure along each dimension relative to the target data structure. The scoring of each dimension can be performed using any suitable known function or composition of functions. A list of best fit candidate employees is generated (134). The list of best fit candidate employees is then outputted (135).

A set of employees is then engaged for the employment term (140). The set of employees are onboarded (150). Workflow module 76 coordinates the collection of any data, forms, background checks, etc. required to onboard the employees. During the employment term, mid-term evaluations can be received (160). Both the employer and the employee can submit evaluation data that is stored by computer system 20. The employees are then offboarded at the end of the employment term (170). Again, workflow module 76 coordinates the collection of any data, forms, etc. Evaluations are then received from the employer and the employee (180). The weightings used by the Al module 88 are then adjusted (i.e., trained) using the feedback (190). Primarily, weightings are used to adjust how computer system 20 treats different criteria. If xᵢ is the score of the candidate data structure and wᵢ is how important that dimension is, the fit score can be determined as Σf(xi,wi). So if a person was scored highly for xᵢ but it didn't matter in their job function, wᵢ might be reduced. This is not necessarily timed to when the candidate finishes because it requires a body of candidates to discover what were useful attributes/dimensions. If successful candidates were hired with a variety of fit scores in one dimension, the weight of that dimension can be reduced. If low scores are preferred in a dimension, that weight can be negative.

While computer system 20 in the above-described embodiment is operated for a single entity or group of entities, it will be appreciated that computer system 20 can also manage human resources across a number of unrelated entities.

Computer-executable instructions for implementing the human resource management system on a computer system could be provided separately from the computer system, for example, on a computer-readable medium (such as, for example, an optical disk, a hard disk, a USB drive or a media card) or by making them available for downloading over a communications network, such as the Internet.

While the computer system is shown as a single physical computer, it will be appreciated that the computer system can include two or more physical computers in communication with each other. Accordingly, while the embodiment shows the various components of the computer system residing on the same physical computer, those skilled in the art will appreciate that the components can reside on separate physical computers.

Persons skilled in the art will appreciate that there are yet more alternative implementations and modifications possible, and that the above examples are only illustrations of one or more implementations. The scope, therefore, is only to be limited by the claims appended hereto.

1. A method for managing human resources, comprising:
storing, in storage of a computer system, personnel data for a plurality of persons;
storing employer-provided evaluation data for a first subset of the plurality of persons;
generating a candidate data structure having a plurality of dimensions from the personnel data and the employer-provided evaluation data for each of a second subset of the plurality of persons;
scoring, for a proposed employment term, the candidate data structure for each of the second subset of the plurality of persons; and
identifying and presenting at least one of the second subset of the plurality of persons at least partially based on the scoring.

2. A method as claimed in claim 1, further comprising:
identifying at least one target data structure having the plurality of dimensions for a target candidate for the proposed employment term,
wherein the scoring comprises comparing at least a subset of the dimensions of the candidate data structure, and the at least one target data structure for each of the second subset of the plurality of past employees.

3. A method as claimed in claim 2, wherein the at least one target data structure comprises at least one of the candidate data structures, the method further comprising:
comparing the candidate data structure for each of the second subset of the plurality of persons to the candidate data structure for a third subset of the first subset of the plurality of persons.

4. A method as claimed in claim 3, wherein the third subset is equal to the first subset.

5. A method as claimed in claim 3, wherein the third subset is smaller than the first subset.

6. A method as claimed in claim 2, wherein the scoring comprises using a weighting to value the differences along each of the subset of the dimensions of the candidate data structure and the target data structure.

7. A method as claimed in claim 6, further comprising:
receiving a selection of the at least one of the second subset of the plurality of persons; and
adjusting the weightings based on the selection.

8. A method as claimed in claim 1, wherein the candidate data structure is a data vector.

9. A method as claimed in claim 1, wherein the candidate data structure is a data graph.

10. A method as claimed in claim 1, wherein the candidate data structure is a hybrid data structure.

11. A human resource management system, comprising:
a storage storing a personnel data for a plurality of persons and employer-provided evaluation data for a first subset of the plurality of persons, the storage storing computer-executable instructions;
a processor that, when executing the computer-executable instructions:
generates a candidate data structure having a plurality of dimensions from the personnel data and the employer-provided evaluation data and the for each of a second subset of the plurality of persons;
scores, for a proposed employment term, the candidate data structure for each of the second subset of the plurality of persons; and
identifies and presents at least one of the second subset of the plurality of persons at least partially based on the scoring.
